(19) United States
(12) Patent Application Publication
(10) Pub. No.: US 2012/0091308 A1
(43) Pub. Date: Apr. 19, 2012

(54) LaRue's two-clip double sided clipboard

(76) Inventors: LaRue D. Small, Algona, IA (US); Jeannie C. Small, Algona, IA (US)

(21) Appl. No.: 12/925,113

(22) Filed: Oct. 14, 2010

(51) Int. Cl. F16B 5/06; B42D 17/00; B23P 17/04

(52) U.S. Cl. 248/452; 29/428; 281/45

(57) ABSTRACT

The present invention discloses a two clip double sided clipboard. The two clip double sided clipboard may comprise a flat clipboard with a clip on each flat surface of the clipboard. The clips may include pads for resting on the flat surfaces of the clipboard.

### BACKGROUND OF THE INVENTION

The present invention relates to the field of clipboards, and more particularly to the field of two-clip double sided clipboards.

### SUMMARY OF THE INVENTION

In one embodiment the invention is a two clip double sided clipboard comprising a board with two flat surfaces; two clips, wherein each of the two clips is positioned on different flat surfaces of the two flat surfaces of the clipboard, and wherein each of the two clips comprises a wire; and two pads attached to each side of the wire at points in which the two pads rest on the board.

In a further embodiment of the invention a two clip double sided clipboard comprises a board; and two clips configured to clamp both sides of the board, wherein the two clips are permanently attached to the board.

In a further embodiment of the invention, a method comprises creating a two clip double sided clipboard, wherein each of two clips are positioned on each of the two flat surfaces of the clipboard; using the two clip double sided clipboard for writing, wherein both sides of the clipboard are used as a background for writing; clamping paper simultaneously onto both sides of the clipboard using the two clips.

### DESCRIPTION OF THE FIGURES

FIG. 1 is a front view of an embodiment of the invention.

FIG. 2 is a side view of an embodiment of the invention.

### DETAILED DESCRIPTION

The following description is not intended to limit the scope of the invention, but to generally illustrate the invention.

Clipboards are used for writing when a desk is not available. However, the clipboards available are one-sided with clamping ability on only one side. Therefore, the present invention improves on the presently available clipboards.

Business persons including attorneys may use many clipboards in their offices and in court. The two clips would allow for confidential papers to be on the other side or notes that have already been addressed sent to the other side. Similar use may be done at doctor offices, hospitals, home care agencies, or other offices.

Steel workers may have two clipboards tied and hanging from their necks. A two clip two sided clipboard would allow them to clip the board to a piece of steel. Construction workers can attach one side of the clipboard to the inside or outside of a van or truck window.

General office workers when making copies of papers can have originals on one side and copies on the other side. The general public and students would benefit if filling out a questionnaire or taking tests to clip finished paper on the backside.

Various types of sports, industries, law enforcement, news organizations, students, the general public, all offices, and all working environments would benefit due to decreasing the number of clipboards they may need while increasing the ability of the clipboard to hold double the papers.

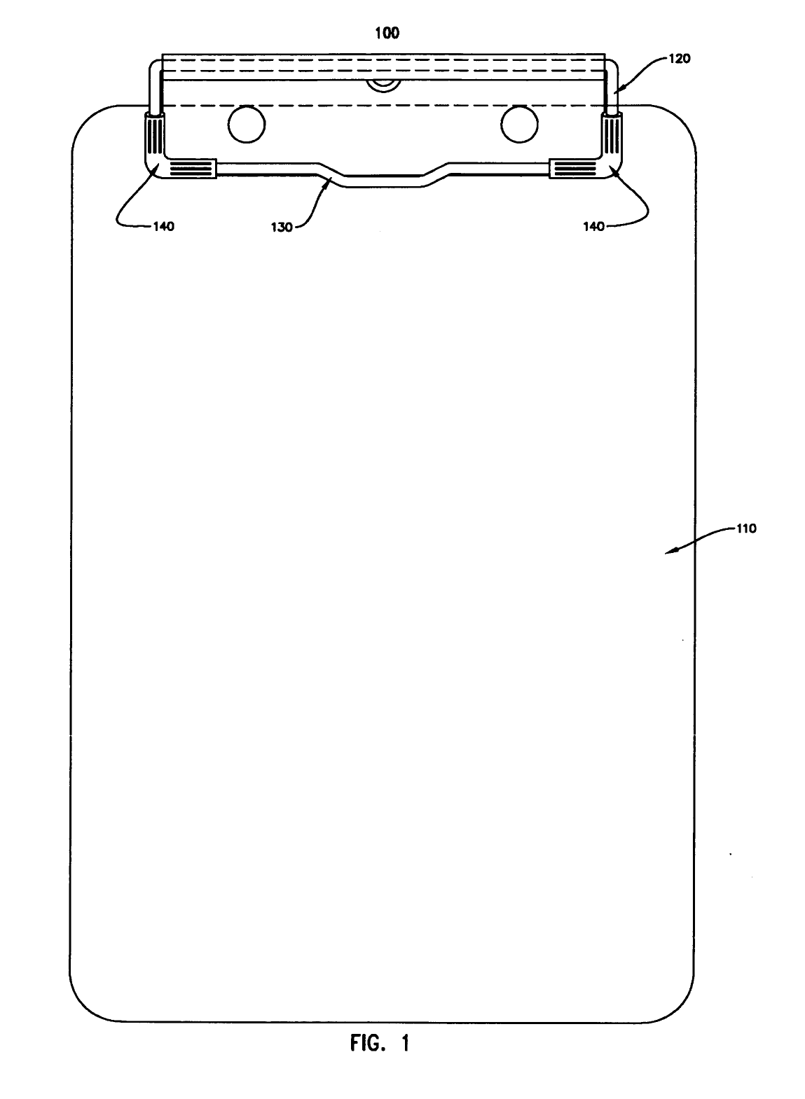

FIG. 1 is a front view of the present invention. At 110 is shown a board component of a two clip double sided clipboard 100. A clip 120 is installed at one end of the clipboard 100. The clip 120 may be comprised of a wire 130 and support pads 140. The clip 120 may prevent paper from moving on the clipboard 100. The clip 120 may also be attached in duplicate form on the other side of the clipboard 100. The clipboard 100 may look the same on both sides of the clipboard 100 with a clip 120 simultaneously on both sides of the clipboard 100.

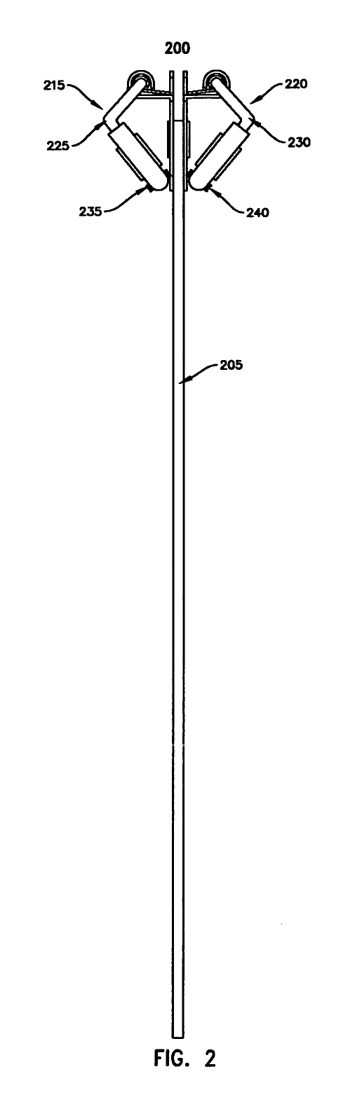

FIG. 2 is a side view of the present invention. At 205 is shown a board component of a clipboard 200. A first clip 215 and a second clip 220 may be installed on opposite sides of the board component 205 of the clipboard 200. The first clip 215 may include a first wire 225 and the second clip 220 may include a second wire 230. The first clip 215 may also include a first support pad 235 and the second clip 220 may include a second support pad 240. The first clip 215 and the second clip 220 may prevent paper from moving on either side of the clipboard 200.

In a further embodiment of the invention, the two clip double sided clipboard 200 may have a different style clip on either side of the clipboard 200, that may include square clips, circular clips, or other clip designs. In a further embodiment of the invention, the two clip double sided clipboard 200 may have a clip with a different style on each of the two sides of the clipboard 200. In a further embodiment of the invention, the invention may have no pads on the clips 215,220. In a further embodiment of the invention, the clips 215,220 may have either a single pad or more than two pads of various designs on each side of the clipboard 200. In a further embodiment of the invention, the clips 215,220 and the clipboard 200 may be of various colors. In a further embodiment of the invention, the clips 215,220 may have a different color on each side of the clipboard 200. In a further embodiment of the invention, the two clips 215,220 may be part of a single piece, with the two clips 215,220 affixed to opposite flat surfaces of the clipboard 200, but the two clips 215,220 attached to each other as a single piece.

The invention may be made of any suitable material including but not limited to, wood products, metal products, plastic products and other natural or human made materials.

The above description may be modified without departing from the scope of the claims below.

1. A two clip double sided clipboard, comprising:
a board with two flat surfaces;
two clips, wherein each of the two clips is positioned on different flat surfaces of the two flat surfaces of the clipboard, and wherein each of the two clips comprises a wire; and
two pads attached to each side of the wire at points in which the two pads rest on the board, wherein half of each of the two clips rise above the top edge of the board.

2.-3. (canceled)

4. A two clip double sided clipboard, comprising:
a board; and
two clips configured to clamp both sides of the board, wherein the two clips are permanently attached to the board, wherein half of each of the two clips rise above the board.

5. The two clip double sided clipboard of claim 4, wherein each of the two clips is a rectangular wire positioned on opposite flat surfaces of the clipboard.

6. The two clip double sided clipboard of claim 4, wherein each of the two clips is configured to form a circle positioned on opposite flat surfaces of the clipboard.

7. A two clip double sided clipboard, comprising:
a board with two flat surfaces on opposite sides of the clipboard; and
two clips, wherein each of the two clips is positioned on opposite flat surfaces of the two flat surfaces of the clipboard,
wherein the two clips are attached as a single piece,
wherein the top of each of the two clips is smooth without holes and without protrusions, and
wherein the two clips are without pads which rest on the clipboard.

8. The two clip double sided clipboard of claim 7, wherein each of the two clips is configured to form a square.
